(19) United States
(12) Patent Application Publication
(10) Pub. No.: US 2008/0235527 A1
(43) Pub. Date: Sep. 25, 2008

(54) Operation of computer display using auxiliary display controller

(75) Inventors: Zeev Heller, Ganei Tikvah (IL); Ilia Stolov, Holon (IL)

Correspondence Address: ABELMAN, FRAYNE & SCHWAB, 666 THIRD AVENUE, 10TH FLOOR, NEW YORK, NY, 10017, US

(73) Assignee: Winbond Electronics Corporation

(21) Appl. No.: 11/725,825

(22) Filed: Mar. 19, 2007

(51) Int. Cl. G06F 1/32

(52) U.S. Cl. 713/320

(57) ABSTRACT

A computing apparatus includes a display, a Central Processing Unit (CPU) having active and switched-off operational states and an auxiliary display controller, which is active when the CPU is in the switched-off operational state. The computing apparatus further includes a switch, which is operative to connect the CPU to the display when the CPU is in the active operational state, so as to display first information produced by the CPU, and to connect the auxiliary display controller to the display when the CPU is in the switched-off operational state, so as to display second information produced by the auxiliary display controller.

### FIELD OF THE INVENTION

The present invention relates generally to computer systems, and particularly to methods and systems for reducing computer power consumption.

### BACKGROUND OF THE INVENTION

Some computer configurations use auxiliary display modules for displaying selected information when the computer is switched off or hibernating. For example, an auxiliary display module can display e-mail messages, calendar entries, news headlines and other information. Some auxiliary display modules comprise an auxiliary display, which is separate from the primary display of the computer.

Windows Sideshow™ is a product family offered by Microsoft Corp. (Redmond, Wash.), which enables a variety of auxiliary display devices to be connected to Windows Vista™ applications. Auxiliary display modules that operate with Windows Sideshow are described, for example, by Fuller in “Auxiliary Display Platform in Longhorn,” Windows Hardware Engineering Conference (WinHEC) 2005, Seattle, Wash., Apr. 25-27, 2005, and by Polivy in “Building Remote and Integrated Auxiliary Display Devices for Windows SideShow,” WinHEC 2006, Seattle, Wash., May 23-25, 2006, which are incorporated herein by reference.

Some aspects of auxiliary display operation are described in the patent literature. For example, U.S. Patent Application Publication 2006/0007051, whose disclosure is incorporated herein by reference, describes a method and system for auxiliary display of information for a computing device. An auxiliary display is integrated with a computing system to provide an area where notifications can be peripherally presented off-screen. Whenever a background task sends a notification to the main display of the system, the notification may be redirected to appear instead on the auxiliary display. The auxiliary display may be placed on the central processor chassis or on the monitor border along with indicator lights to provide simple peripheral-vision notification. By pressing a button, a user may obtain additional detailed follow-up information.

U.S. Patent Application Publication 2005/0243021, whose disclosure is incorporated herein by reference, describes an architecture by which application programs can provide data to auxiliary display devices for display to a user. A defined application layer allows programs to provide data to a service, which controls the output of data to an auxiliary display device and returns navigational data to the application upon appropriate user interaction with the device via actuators. The architecture further provides a protocol layer that allows various types of displays to serve as an auxiliary display.

Auxiliary display devices are also described in U.S. Patent Application Publications 2005/0262302, 2005/0243019 and 2005/0243020, whose disclosures are incorporated herein by reference.

### SUMMARY OF THE INVENTION

There is provided, in accordance with an embodiment of the present invention, a computing apparatus, including:

a display;

a Central Processing Unit (CPU), having active and switched-off operational states;

an auxiliary display controller, which is active when the CPU is in the switched-off operational state; and

a switch, which is operative to connect the CPU to the display when the CPU is in the active operational state, so as to display first information produced by the CPU, and to connect the auxiliary display controller to the display when the CPU is in the switched-off operational state, so as to display second information produced by the auxiliary display controller.

In some embodiments, the apparatus further includes a power source, which is operative to provide electrical power for operating the apparatus, the CPU draws a first power level from the power source, and the auxiliary display controller draws from the power source a second power level, which is lower than the first power level.

In a disclosed embodiment, the apparatus includes an embedded controller, and at least one processor selected from a group of processors consisting of the embedded controller, the auxiliary display controller and the CPU is arranged to evaluate a switching condition and to control the switch based on the switching condition. In another embodiment, the apparatus includes a power source that is operative to provide electrical power for operating the apparatus, and the switching condition depends on a status of the power source.

In yet another embodiment, the auxiliary display controller is arranged to display the second information in a partial region of the display. In still another embodiment, the auxiliary display controller is arranged to output the second information in a display signal having a first display format, the display supports a second display format different from the first display format, and the apparatus includes a transceiver, which is arranged to convert the display signal produced by the auxiliary display controller from the first format to the second format and to provide the converted display signal to the display.

In an embodiment, the CPU and the auxiliary display controller are arranged to communicate with one another so as to exchange data when switching between the active and switched-off operational states. The data exchanged between the CPU and the auxiliary display controller may include program code to be executed by the auxiliary display controller.

In some embodiments, the apparatus includes a keyboard, the CPU is arranged to accept input from a user using the keyboard and to act upon the input so as to interact with the user in the active operational state, and the auxiliary display controller is arranged to accept the input from the user using the keyboard and to act upon the input so as to interact with the user in the switched-off operational state. The auxiliary display controller may be arranged to run a software application that enables the user to manipulate data using the keyboard and the display when in the switched-off operational state, and to provide the manipulated data to the CPU when switching to the active operational state.

There is additionally provided, in accordance with an embodiment of the present invention, a computing method, including:

operating a Central Processing Unit (CPU), which has active and switched-off operational states, and an auxiliary display controller, which is active when the CPU is in the switched-off operational state;

displaying first information produced by the CPU on a display by controlling a switch to connect the display to the CPU when the CPU is in the active operational state; and

displaying second information produced by the auxiliary display controller on the display by controlling the switch to connect the display to the auxiliary display controller when the CPU is in the switched-off operational state.

There is also provided, in accordance with an embodiment of the present invention, a computer software product used in a computer that includes a display, a Central Processing Unit (CPU), which has active and switched-off operational states, and an auxiliary display controller, which is active when the CPU is in the switched-off operational state, the product including a computer-readable medium, in which program instructions are stored, which instructions, when read by a computer, cause the computer to display first information produced by the CPU on the display by controlling a switch to connect the display to the CPU when the CPU is in the active operational state, and to display second information produced by the auxiliary display controller on the display by controlling the switch to connect the display to the auxiliary display controller when the CPU is in the switched-off operational state.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer, in accordance with an embodiment of the present invention; and

FIG. 2 is a flow chart that schematically illustrates a method for switching computer operation between a Central Processing Unit (CPU) and an auxiliary display controller, in accordance with an embodiment of the present invention.

### DETAILED DESCRIPTION OF EMBODIMENTS

### Overview

Low power consumption is a prime consideration in the design of many computing platforms. Reducing power consumption increases the computer's battery life, reduces heat generation, increases the reliability of the computer and helps to comply with environmental standards. A significant portion of the power consumed by the computer is due to the Central Processing Unit (CPU) and its peripheral components, particularly when these devices operate at high clock rates.

In order to conserve power, computers often have one or more predefined switched-off operational states, in which the CPU and its peripheral components, as well as other elements of the computer, are deactivated.

Embodiments of the present invention provide methods and systems for operating the computer, and in particular for displaying information on the computer display, when the computer is switched-off, e.g., in sleep mode or hibernating. In accordance with these methods and systems, the computer comprises an auxiliary display controller, which drives the computer display and displays information to the user when the CPU is in a switched-off state. The auxiliary display controller usually has a simpler architecture and significantly less computing power in comparison with the CPU, main memory and system chipset, but on the other hand it consumes much less power.

The computer further comprises a switch, which selects whether the computer display is driven by the CPU or by the auxiliary display controller. By default, the switch normally connects the display to the CPU chipset. When low-power operation is desired, the switch is toggled so that the display is driven by the auxiliary display controller. In some embodiments, the switch is controlled by an embedded controller, which is constantly active, regardless of the operational state of the CPU and auxiliary display controller. In alternative embodiments, the switch is controlled by the auxiliary display controller.

Switching the display to the auxiliary display controller can be triggered by various conditions or events. For example, the auxiliary display controller may drive the display whenever the main system (CPU chipset) enters a switched-off state, in response to a user command, and/or when the computer battery is low or exhausted. Typically, the main system and auxiliary display controller communicate with one another to exchange data and/or application code before switching the display between them.

In addition to displaying information on the computer display, the auxiliary display controller can sometimes run applications and/or interact with the user. For example, the auxiliary display controller may accept, via the embedded controller, user input that is entered using the computer keyboard. The auxiliary display controller may run a limited-functionality operating system, run applications that match its computational power and architecture, and/or store data in its memory. As a result, the user is provided a partial-capability computing mode, in which the computer is operational but draws only a fraction of its normal power consumption.

Moreover, the methods and systems described herein enable the user to access time-critical information rapidly using the computer display, when the main system is switched off. When using known methods, accessing information when the main system is off involves booting the main CPU chipset with its operating system and application, a process that is often several minutes long. Using the methods and systems described herein, on the other hand, information can be displayed to the user almost instantly, within seconds. This feature can also be used when the main CPU chipset is active.

### System Description

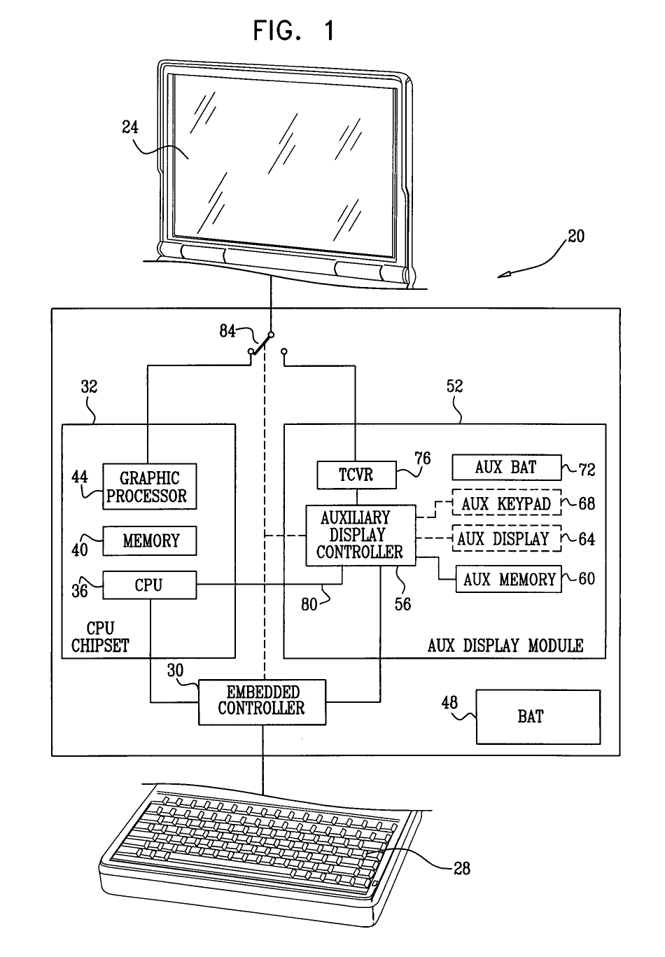

FIG. 1 is a block diagram that schematically illustrates a computer 20, in accordance with an embodiment of the present invention. Computer 20 may comprise a laptop, notebook or tablet computer, a desktop computer, an ultra-mobile computing device, or any other suitable computing platform. Generally, the methods and systems described herein can be used to reduce power consumption in any computing platform that outputs information to a display or screen.

Computer 20 comprises a display 24, on which the computer displays information to a user, and a keyboard 28, using which the user inputs information to the computer. The computer comprises an embedded controller 30, which performs various power management functions of the computer, and in particular activates and deactivates different computer components, as appropriate. Embedded controller 30 is active continuously, regardless of the operational state of the computer. In addition, embedded controller 30 reads the keystrokes typed on keyboard 28 and provides the typed input to the computer.

Computer 20 comprises a Central Processing Unit (CPU) chipset 32, which comprises a CPU 36, a memory 40 and a Graphic Processor (GP) 44. Chipset 32 may have any suitable configuration known in the art. For example, CPU 36 may comprise any known microprocessor or combination of microprocessors, and memory 40 may comprise one or more memory devices of any type. CPU chipset 32 and display 24, as well as other elements of computer 20, are powered by a battery 48.

GP 44 produces a display signal, which carries the information that is generated by CPU chipset 32 for display on display 24. The display signal produced by GP 44 may conform to any known digital graphics standard, such as the Video Graphics Array (VGA), Super VGA (SVGA), extended Graphic Array (XGA), as well as other standards, such as the Video Electronics Standards Association (VESA) display standards. The signal is provided to display 24 using a high-speed digital interface, such as using Low Voltage Differential Signaling (LVDS).

### Computer Operation in Switched-Off Operational States

In order to reduce the power drawn from battery 48, computer 20 can enter one or more switched-off operational states. In the context of the present patent application and in the claims, the term “switched off” is used to describe various possible operational modes and states, in which most functions of the computer are disabled, in order to conserve power. Switched-off states may comprise, for example, states or modes in which the computer is turned off, in sleep mode, hibernating or standing by. In particular, CPU chipset 32 is deactivated when the computer is switched-off.

Transitions between the different operational states are typically managed by embedded controller 30, which is constantly active. Entry into a switched-off state can be triggered by various conditions and events, as will be described in detail further below.

Computer 20 further comprises an auxiliary display module 52, which is used for displaying information to the user when the CPU chipset is switched-off. Module 52 may reside on the same circuit board as CPU chipset 32 or may alternatively comprise a separate unit. The auxiliary display module comprises an auxiliary display controller 56, which processes the information to be displayed, and an auxiliary memory 60, in which controller 56 stores information and/or program code.

In some embodiments, controller 56 drives display 24 using a transceiver 76. Transceiver 76 generates a display signal, such as an LVDS signal, according to the appropriate interface or format used for driving display 24. Transceiver 76 is typically used to translate one type of display format to another. For example, in some embodiments, auxiliary display controller 56 may produce a display signal having an RGB 565 format, whereas display 24 is configured to use four-wire LVDS input. In such cases, transceiver 76 translates the display signal provided by controller 56 to the format supported by display 24. In embodiments in which display 24 supports the format generated by controller 56, transceiver 76 may be omitted.

Optionally, controller 56 may also display information on an auxiliary display 64, which is separate from display 24. In these embodiments, module 52 sometimes comprises an auxiliary keypad 68, using which the user scrolls, selects or otherwise manipulates the information displayed by the auxiliary display module. The keypad normally comprises a small number of keys, such as arrow keys and/or an “enter” key. Although typically module 52 is powered by battery 48, in some cases the auxiliary display module comprises an additional, auxiliary battery 72. Different kinds of auxiliary displays and keypads are described in the references cited in the Background section hereinabove.

Auxiliary display controller 56 and CPU 36 communicate with one another using an interface 80, for example in order to coordinate operational state transitions and to exchange data and/or program code. In some embodiments, interface 80 comprises a Universal Serial Bus (USB) interface. Alternatively, any other suitable interface, such as a Bluetooth™ link, can be used. Auxiliary display controller 56 can be connected to embedded controller 30 by a System Management Bus (SMBus) interface, as is known in the art, or using any other suitable interface.

Computer 20 comprises a switch 84, which selects whether to drive display 24 with the output of GP 44 or with the output of transceiver 76. In other words, switch 84 determines whether the display displays the information produced by CPU 36 or the information produced by auxiliary display controller 56. As will be explained below, the switch may be controlled either by auxiliary display controller 56 or by embedded controller 30.

In some embodiments, switch 84 and transceiver 76 are integrated in a single device. In other embodiments, switch 84 and possibly transceiver 76 are integrated within auxiliary display controller 56. In these embodiments, the output of GP 44 is provided to controller 56.

Typically, CPU 36, embedded controller 30 and auxiliary display controller 56 comprise general-purpose processors, which are programmed in software to carry out the functions described herein. The software may be downloaded to the processors in electronic form, over a network, for example, or it may alternatively be supplied to the processors on tangible media, such as CD-ROM.

Auxiliary display controller 56 may comprise a Windows Sideshow compatible device, such as the WPCE521L device offered by Winbond Electronics Corp. (San Jose, Calif.). Further details regarding this device are available at www.winbond-usa.com/mambo/content/view/340/573/. Embedded controller 30 may comprise, for example, the PC97551 device, offered by Winbond Electronics. Further details regarding this device are available at http://www.winbond-usa.com/mambo/content/view/312/535/.

Elements of computer 20 that are not essential to the understanding of the principles of the present invention have been omitted from FIG. 1 for the sake of clarity. Such elements may comprise, for example, magnetic storage devices, communication devices and/or various Input/Output (I/O) devices.

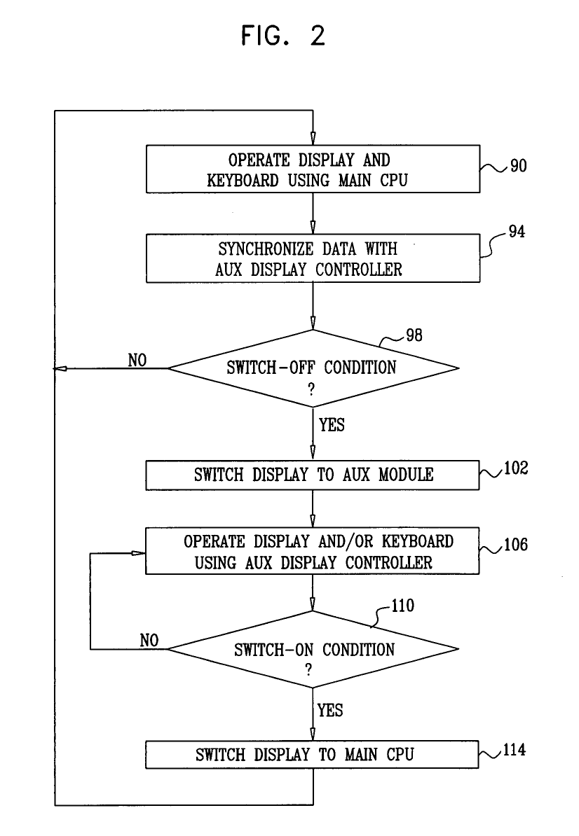

FIG. 2 is a flow chart that schematically illustrates a method for switching the operation of computer 20 between CPU 36 and auxiliary display controller 56, in accordance with an embodiment of the present invention. The method begins with the computer in an active operational state, at an active operation step 90. In this state, display 24 and keyboard 28 are operated by CPU chipset 32. Switch 84 is switched to drive display 24 with the output of graphic processor 44.

CPU 32 and auxiliary display controller 56 exchange information in order to prepare for a possible transition to a switched-off state, at a data synchronization step 94. The information sent from the CPU to the auxiliary display controller may comprise, for example, up-to-date values of the information items displayed by the auxiliary display controller, and/or program code that will be executed by the auxiliary display controller when the computer operates in the switched-off state. The auxiliary display controller may acknowledge the received information over interface 80, or send any other information to CPU 36.

Embedded controller 30 determines whether to initiate a transition into a switched-off operational state, at a switch-off condition evaluation step 98. Transition into a switched-off state can be triggered by various events or conditions. For example, the computer can be switched off or put in standby by the user, such as using an on/off switch or keyboard command. The computer may also enter the switched-off state automatically, if no user activity (e.g., keyboard strokes or mouse movements) is detected for a certain time period. Automatic transition into the switched-off state can also be performed when battery 48 is low or exhausted, e.g., when its voltage drops below a certain threshold. In these embodiments, the embedded controller or auxiliary display controller monitors the battery status and sets switch 84 accordingly. Additionally or alternatively, the embedded controller can evaluate any other suitable condition in order to determine whether to enter the switched-off state.

As long as no switch-off condition is met, the computer continues to operate in the active state, at steps 90 and 94. When the switch-off condition is met, the embedded controller toggles switch 84, at an auxiliary switching step 102. Switch 84 is set so that display 24 is driven with the output of transceiver 76, i.e., with the information produced by the auxiliary display controller. The computer enters and begins to operate in the switched-off state, at a switched-off operation step 106. The embedded controller deactivates CPU chipset 32, or parts of the chipset, in order to reduce the power drawn from battery 48.

During switched-off state operation, auxiliary display controller displays information on display 24. In some embodiments, the information is displayed in a specific partial region of display 24, such as in a single line at the top or bottom of the screen, or in any other suitable region. Limiting the display to a relatively small region of the screen reduces the power consumption of display 24, as well as the size of memory 60.

For example, in some cases display 24 comprises multiple back-lighting lamps. When the information is displayed in only a small region of the display, some of the lamps can be deactivated to reduce power consumption.

As noted above, the auxiliary display controller may run certain applications when the computer is in the switched-off state. In some cases, the auxiliary display controller runs an operating system, such as Windows Mobile, Windows CE, .NET Micro Framework. The auxiliary display controller typically stores the data used by the applications in memory 60.

Since embedded controller 30 is active regardless of the operational state of the computer, the embedded controller can continuously monitor keyboard 28 and provide any user input typed on the keyboard to auxiliary display controller 56. Thus, the applications and/or operating system running on the auxiliary display controller can involve accepting user input from keyboard 28. In some embodiments, the embedded controller can accept input from additional input devices, such as a mouse, and provide this input to the operating system and/or application running on auxiliary display controller 56.

For example, when CPU 36 runs an e-mail application, the auxiliary display controller can run a limited-functionality application that lets the user review and answer e-mail messages received by the main e-mail application of the CPU, and/or to compose new messages. Before switching to the switched-off state, the CPU sends some or all of the e-mail messages, such as the set of unanswered messages, to the auxiliary display controller, at step 94 above. In the switched-off state, the user can review and respond to these messages using the application running on the auxiliary display controller. When returning to active state operation, the auxiliary display controller sends the newly-created messages to the main e-mail application of the CPU, which sends the messages to their destinations.

The auxiliary display controller can also run applications that enable the user to compose documents and/or mail messages, manipulate calendar entries, task lists, notes, alerts and/or contacts, use an on-screen calculator and/or perform any other suitable task that manipulates data using display 24 and/or keyboard 28 when the computer is in the switched-off state. Typically, the manipulated data is provided to CPU 36 when switching to the active operational state.

As can be appreciated, running such applications on controller 56 enables computer 20 to function in the switched-off state as a fully-operational, although limited functionality computer, while drawing only minimal battery power. Depending on the specific battery and display being used, as much as 70-85% power saving can be achieved in this state, with respect to the active state power consumption at step 90 above. Consequently, the computer is able to operate for many hours without recharging battery 48. In many cases, the operating time without recharging is increased by a factor of four to six.

As noted above, auxiliary display controller 56 also enables the use to access time-critical information quickly, without having to boot the CPU chipset with its operating system and application.

During switched-off operation, embedded controller 30 checks whether to transition to the active operational state, at a switch-on condition evaluation step 110. Events that trigger a transition to the active state may comprise, for example, a user turning the computer on or waking the computer from hibernation, or any other suitable event or condition.

When the switch-on condition is met, the embedded controller sets switch 84 so that display 24 is driven by graphic processor 44 of CPU chipset 32. The embedded controller activates the CPU chipset. The CPU and auxiliary display controller may communicate with one another, so as to synchronize the CPU with information that may have changed during switched-off operation. As described above, the information sent to the CPU may comprise information, which was produced by an application running on the auxiliary display controller. Optionally, the embedded controller may deactivate auxiliary module 52. The method then loops back to step 90 above, and computer continues to operate in the active state.

FIG. 2 above shows an exemplary method description. Alternatively, any other suitable method for switching the operation of computer 20 between CPU 36 and auxiliary display controller 56 can also be used. For example, evaluating the switch-off condition (at step 98 above) can be carried out by auxiliary display controller 56 or by CPU 32, instead of by embedded controller 30. Similarly, evaluation of the switch-on condition (at step 110 above) can be carried out by controller 56. In the description of FIG. 2, the auxiliary display controller interacts with the user using keyboard 28. Alternative, simpler implementations that involve only information display without user interaction can also be used.

The description of FIG. 2 referred to a single switched-off operational state. In alternative embodiments, computer 20 may have multiple switched-off states that differ from one another in functionality, and in the conditions or events that trigger transition into and out of each state. The auxiliary display controller may be used in only a subset of the switched-off states, and/or may have different functionality in each state. The auxiliary display module can be deactivated or it may remain active when the CPU chipset is active.

Although the embodiments described herein mainly address mobile computing devices, the principles of the present invention can also be used in any other computing platform in which power-saving operation is desirable. Such platforms may comprise, for example, notebooks, ultra-mobile systems, industrial PC designs, tablet PCs and many others.

Although the embodiments described herein refer to reducing the power drawn from a battery, the methods and systems described herein can also be used for reducing the power consumption from other types of power sources. For example, reducing the power drawn by a mains-powered computer can be desirable for reducing heat, reducing operational costs and increasing the reliability of the computer.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A computing apparatus, comprising:
a display;
a Central Processing Unit (CPU), having active and switched-off operational states;
an auxiliary display controller, which is active when the CPU is in the switched-off operational state; and
a switch, which is operative to connect the CPU to the display when the CPU is in the active operational state, so as to display first information produced by the CPU, and to connect the auxiliary display controller to the display when the CPU is in the switched-off operational state, so as to display second information produced by the auxiliary display controller.

2. The apparatus according to claim 1, and comprising a power source, which is operative to provide electrical power for operating the apparatus, wherein the CPU draws a first power level from the power source, and wherein the auxiliary display controller draws from the power source a second power level, which is lower than the first power level.

3. The apparatus according to claim 1, and comprising an embedded controller, wherein at least one processor selected from a group of processors consisting of the embedded controller, the auxiliary display controller and the CPU is arranged to evaluate a switching condition and to control the switch based on the switching condition.

4. The apparatus according to claim 3, and comprising a power source that is operative to provide electrical power for operating the apparatus, wherein the switching condition depends on a status of the power source.

5. The apparatus according to claim 1, wherein the auxiliary display controller is arranged to display the second information in a partial region of the display.

6. The apparatus according to claim 1, wherein the auxiliary display controller is arranged to output the second information in a display signal having a first display format, wherein the display supports a second display format different from the first display format, and comprising a transceiver, which is arranged to convert the display signal produced by the auxiliary display controller from the first format to the second format and to provide the converted display signal to the display.

7. The apparatus according to claim 1, wherein the CPU and the auxiliary display controller are arranged to communicate with one another so as to exchange data when switching between the active and switched-off operational states.

8. The apparatus according to claim 7, wherein the data exchanged between the CPU and the auxiliary display controller comprises program code to be executed by the auxiliary display controller.

9. The apparatus according to claim 1, and comprising a keyboard, wherein the CPU is arranged to accept input from a user using the keyboard and to act upon the input so as to interact with the user in the active operational state, and wherein the auxiliary display controller is arranged to accept the input from the user using the keyboard and to act upon the input so as to interact with the user in the switched-off operational state.

10. The apparatus according to claim 9, wherein the auxiliary display controller is arranged to run a software application that enables the user to manipulate data using the keyboard and the display when in the switched-off operational state, and to provide the manipulated data to the CPU when switching to the active operational state.

11. A computing method, comprising:
operating a Central Processing Unit (CPU), which has active and switched-off operational states, and an auxiliary display controller, which is active when the CPU is in the switched-off operational state;
displaying first information produced by the CPU on a display by controlling a switch to connect the display to the CPU when the CPU is in the active operational state; and
displaying second information produced by the auxiliary display controller on the display by controlling the switch to connect the display to the auxiliary display controller when the CPU is in the switched-off operational state.

12. The method according to claim 11, wherein operating the CPU comprises drawing a first power level from a power source, and wherein operating the auxiliary display controller comprises drawing from the power source a second power level, which is lower than the first power level.

13. The method according to claim 11, wherein controlling the switch comprises evaluating a switching condition and setting the switch to connect the display to one of the CPU and the auxiliary display controller based on the switching condition.

14. The method according to claim 13, wherein the switching condition depends on a status of a power source that provides electrical power for operating the CPU.

15. The method according to claim 11, wherein displaying the second information comprises displaying the second information in a partial region of the display.

16. The method according to claim 11, wherein the second information is outputted by the auxiliary display controller as a display signal having a first display format, and wherein displaying the second information comprises converting the display signal produced by the auxiliary display controller from the first format to a second format supported by the display, and providing the converted display signal to the display.

17. The method according to claim 11, wherein operating the CPU and the auxiliary display controller comprises communicating between the CPU and the auxiliary display controller so as to exchange data when switching between the active and switched-off operational states.

18. The method according to claim 17, wherein communicating between the CPU and the auxiliary display controller comprises sending from the CPU program code to be executed by the auxiliary display controller.

19. The method according to claim 11, wherein operating the CPU comprises accepting input from a user using a keyboard and acting upon the input so as to interact with the user in the active operational state, and wherein operating the auxiliary display controller comprises accepting the input from the user using the keyboard and acting upon the input so as to interact with the user in the switched-off operational state.

20. The method according to claim 19, wherein operating the auxiliary display controller comprises running on the auxiliary display controller a software application that enables the user to manipulate data using the keyboard and the display when in the switched-off operational state, and providing the manipulated data to the CPU when switching to the active operational state.

21. A computer software product used in a computer that includes a display, a Central Processing Unit (CPU), which has active and switched-off operational states, and an auxiliary display controller, which is active when the CPU is in the switched-off operational state, the product comprising a computer-readable medium, in which program instructions are stored, which instructions, when read by a computer, cause the computer to display first information produced by the CPU on the display by controlling a switch to connect the display to the CPU when the CPU is in the active operational state, and to display second information produced by the auxiliary display controller on the display by controlling the switch to connect the display to the auxiliary display controller when the CPU is in the switched-off operational state.

22. The product according to claim 21, wherein the CPU draws a first power from a power source, and wherein the auxiliary display controller draws from the power source a second power, which is lower than the first power.

23. The product according to claim 22, wherein the instructions cause the computer to monitor a status of the power source and to control the switch to connect the display to one of the CPU and the auxiliary display controller based on the monitored status.

24. The product according to claim 21, wherein the instructions cause the computer to display the second information produced by the auxiliary display controller in a partial region of the display.

25. The product according to claim 21, wherein the instructions cause the CPU to accept input from a user using a keyboard and to act upon the input so as to interact with the user in the active operational state, and wherein the instructions cause the auxiliary display controller to accept the input from the user using the keyboard and to act upon the input so as to interact with the user in the switched-off operational state.

26. The product according to claim 25, wherein the instructions cause the auxiliary display controller to run a software application that enables the user to manipulate data using the keyboard and the display when in the switched-off operational state, and to provide the manipulated data to the CPU when switching to the active operational state.
